(19) United States
(12) Patent Application Publication
(10) Pub. No.: US 2013/0044052 A1
(43) Pub. Date: Feb. 21, 2013

(54) APPARATUS TO RECOGNIZE A STRAIN IN A FLEXIBLE DISPLAY

(71) Applicants: Jun-Hwa HONG, Seoul (KR); Song LIM, Seoul (KR)

(72) Inventors: Jun-Hwa HONG, Seoul (KR); Song LIM, Seoul (KR)

(73) Assignee: PANTECH CO., LTD., Seoul (KR)

(21) Appl. No.: 13/563,712

(22) Filed: Jul. 31, 2012

(30) Foreign Application Priority Data
Aug. 16, 2011 (KR) 10-2011-0081399

(51) Int. Cl. G06F 3/01

(52) U.S. Cl. 345/156

(57) ABSTRACT

An apparatus to recognize a strain in a flexible display includes a recognition unit to include a first panel and a second panel that are formed of an Indium Tin Oxide (ITO) film, which is a transparent conductive film coated with uniform electric constant, and an adhesion layer disposed between the first panel and the second panel, in which the recognition unit is connected to the flexible display and outputs an electric potential value according to the strain in the flexible display; a memory to store an operation pattern information that corresponds to a state of the strain of the flexible display; and a control unit to determine the state of the strain according to the electric potential value, and to execute an operation corresponding to the operation pattern information.

### CROSS-REFERENCE TO RELATED APPLICATION

This application claims priority from and the benefit under 35 U.S.C. §119(a) of Korean Patent Application No. 10-2011-0081399, filed on Aug. 16, 2011, the disclosure of which is incorporated by reference in its entirety for all purposes.

### BACKGROUND

1. Field

The following description relates to a flexible display technology, and more particularly to, an apparatus to recognize a strain in a flexible display.

2. Discussion of the Background

Flexible display technology involves forming a bendable and rollable display using a substrate, which may be made of a flexible material, such as plastic, without damaging the substrate. The flexible display may provide flexibility of display beyond that of the flat panel display technology, and may be called a paper-like display or a digital paper.

A state of a strain in the flexible display may be used as a control signal that controls the operation of an electronic device. In engineering terms, strain generally refers to a fraction calculated as an element's change in dimension divided by its original dimension. The dimension could be a length, width, or thickness, for example, or could be a dimension that is oblique to a length, width, or thickness. Thus, a strain could be measured in a reference direction. Further, strain may be linearly related to a material's modulus of elasticity and applied stress in an elastic region, and may be non-linearly related to a material's modulus of elasticity and applied stress beyond the elastic region. By considering the material properties of the flexible display, the state of strain of the flexible display may be used as a control signal while the flexible display is in the elastic region or deformed beyond the elastic region.

The above information disclosed in this background section is provided for enhancement of understanding of the background of the invention and therefore it may contain information that may not be prior art that is already known in this country to a person of ordinary skill in the art.

### SUMMARY

Exemplary embodiments of the present invention provided an apparatus to recognize a strain in a flexible display.

Exemplary embodiments of the present invention provided an apparatus to control an operation of an electronic device according to a state of a strain in a flexible display.

Additional features of the invention will be set forth in the description which follows, and in part will be apparent from the description, or may be learned by practice of the invention.

Exemplary embodiments of the present invention provide a terminal including a flexible display to display an image; a recognition unit to receive a physical input, and to detect a strain in the flexible display associated with the physical input; and a control unit to determine a state of the strain, and to execute an operation according to the determined state of the strain.

Exemplary embodiments of the present invention provide an apparatus to recognize a strain in a flexible display including a recognition unit to detect the strain in the flexible display, and to output an electric potential value; a memory to store an operation pattern information that corresponds to a state of the strain in the flexible display; and a control unit to determine the state of the strain based on the electric potential value, and to execute an operation corresponding to the operation pattern information, in which the recognition unit comprises a first panel, a second panel formed of an Indium Tin Oxide (ITO) film coated with a uniform electric constant, and an adhesion layer disposed between the first panel and the second panel, and the recognition unit is connected to the flexible display.

Exemplary embodiments of the present invention provide an apparatus to detect a strain in a flexible display a recognition unit to receive a physical input, to detect the strain in the flexible display associated with the physical input, and to output an electric potential value based on the strain; and a control unit to determine a state of the strain based on the electric potential value, and to execute an operation corresponding to the state of the strain, in which the state of the strain is associated with at least one of a position of the strain, a direction of the strain, and a bending strength of the flexible display.

It is to be understood that both the foregoing general description and the following detailed description are exemplary and explanatory and are intended to provide further explanation of the invention as claimed. Other features will be apparent to those skilled in the art from the following detailed description, drawings, and claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1A is a cross sectional view illustrating a flexible display according to an exemplary embodiment of the present invention.

FIG. 1B is a cross sectional view illustrating a flexible display according to an exemplary embodiment of the present invention.

FIG. 2A, FIG. 2B, and FIG. 2C are views illustrating a recognition unit according to an exemplary embodiment of the present invention.

FIG. 3 is a block diagram illustrating an apparatus to recognize a strain in a flexible display according to an exemplary embodiment of the present invention.

FIG. 4 is a plan view illustrating a flexible display equipped with a recognition unit according to an exemplary embodiment of the present invention.

FIG. 5A, FIG. 5B, and FIG. 5C are views used to explain a position of a strain in a flexible display according to an exemplary embodiment of the present invention.

FIG. 6 is a view illustrating detecting coordinates of three or more points associated with a strain in a flexible display according to an exemplary embodiment of the present invention.

FIG. 7 is a view illustrating detecting a direction of a strain in a flexible display according to an exemplary embodiment of the present invention.

FIG. 8A, FIG. 8B, and FIG. 8C are views illustrating recognizing a direction of a strain in a flexible display by use of a central point according to an exemplary embodiment of the present invention.

FIG. 9 is a view illustrating detecting a direction of a strain in a flexible display by use of a change of a slope according to an exemplary embodiment of the present invention.

FIG. 10 is a view illustrating detecting a direction of a strain in a flexible display by use of a change of area according to an exemplary embodiment of the present invention.

FIG. 11A and FIG. 11B are views illustrating detecting a bending strength according to a strain in a flexible display according to an exemplary embodiment of the present invention.

FIG. 12A, FIG. 12B and FIG. 12C are views illustrating detecting a bending strength according to a strain in a flexible display according to an exemplary embodiment of the present invention.

FIG. 13 is a view illustrating an operation pattern mapped to a state of a strain in a flexible display according to an exemplary embodiment of the present invention.

FIG. 14A is a view illustrating an operation pattern mapped to a state of a strain in a flexible display according to an exemplary embodiments of the present invention.

FIG. 14B is a view illustrating an operation pattern mapped to a state of a strain in a flexible display according to an exemplary embodiment of the present invention.

FIG. 15 is a view illustrating an operation pattern mapped to a state of a strain in a flexible display according to an exemplary embodiment of the present invention.

FIG. 16 is a view illustrating an operation pattern mapped to a state of a strain in a flexible display according to an exemplary embodiment of the present invention.

FIG. 17A is a view illustrating an operation pattern mapped to a state of a strain in a flexible display according to an exemplary embodiment of the present invention.

FIG. 17B is a view illustrating an operation pattern mapped to a state of a strain in a flexible display according to an exemplary embodiment of the present invention.

FIG. 18 is a view illustrating an operation pattern mapped to a state of a strain in a flexible display according to an exemplary embodiment of the present invention.

Elements, features, and structures are denoted by the same reference numerals throughout the drawings and the detailed description, and the size and proportions of some elements may be exaggerated in the drawings for clarity and convenience.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art.

It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). It will be further understood that when an element is referred to as being “on” or “connected to” another element, it can be directly on, or directly connected to the other element, or intervening elements may be present.

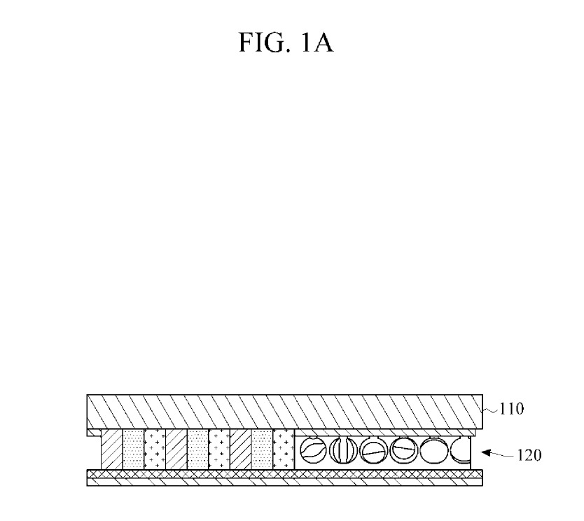

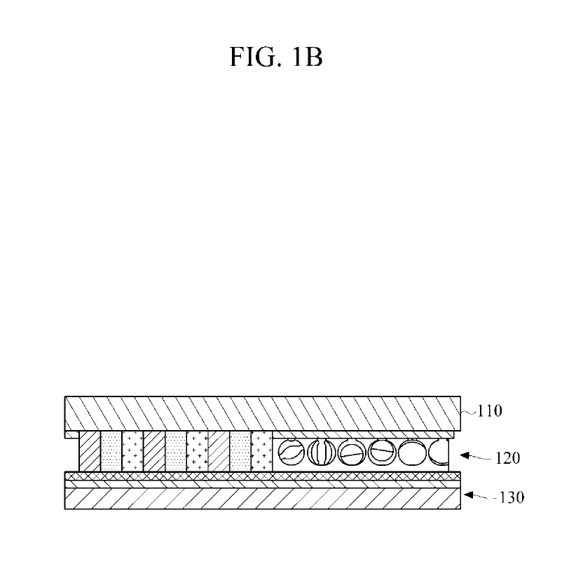

FIG. 1A is a cross sectional view illustrating a flexible display according to an exemplary embodiment of the present invention.

Referring to FIG. 1A, a flexible display 120 is provided with an input unit 110. The input unit 110 is disposed on an upper surface of the flexible display 120. The input unit 110 may be implemented using a touch screen to receive information from a user. The input unit 110 may serve as a recognition unit to recognize a physical strain of the flexible display 120.

FIG. 1B is a cross sectional view illustrating a flexible display according to an exemplary embodiment of the present invention.

Referring to FIG. 1B, the flexible display 120 is disposed on a recognition unit 130, which may be used to recognize the physical strain of the flexible display 120. Further, the recognition unit 130 may be disposed on a partial area or an entire area of the flexible display 120. Detailed descriptions thereof will be made later.

The recognition unit 130 has a structure including an upper panel and a lower panel that may be formed using a transparent conductive film, such as an Indium Tin Oxide (ITO) film coated with uniform electric constant.

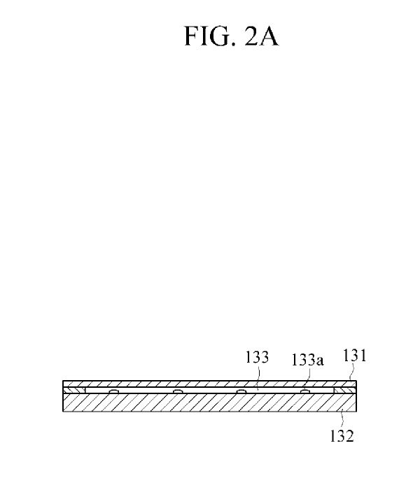

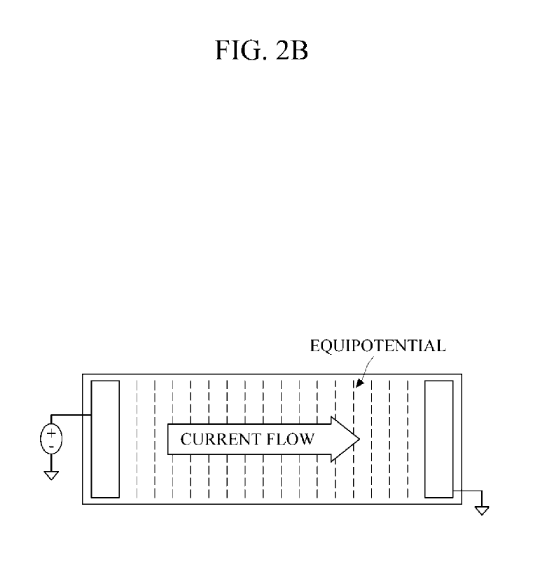

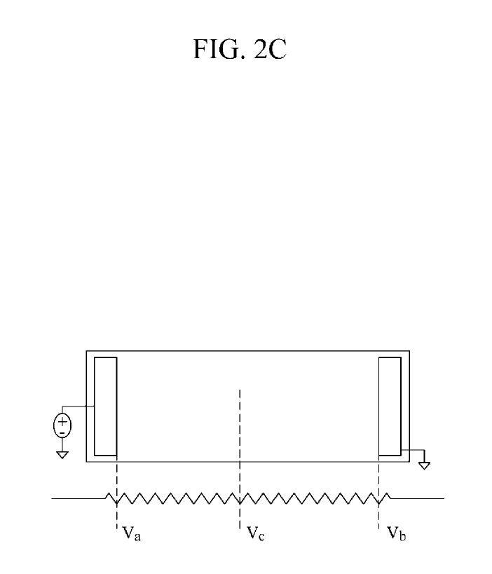

FIG. 2A, FIG. 2B, and FIG. 2C are views illustrating a recognition unit according to an exemplary embodiment of the present invention.

Referring to FIG. 2A, the recognition unit 130 includes an upper plate 131 and a lower panel 132 that may be formed using an ITO film. Dots may be formed on the upper surface of the lower panel 132 such that an adhesion layer 133, which includes a space having the dots, may be provided between the upper panel 131 and the lower panel 132.

If a pressure (or force or stress) is applied to the recognition unit 130, a portion of the upper panel 131 may become bent and an electrical state of a contact point between the upper panel 131 and the lower panel 132 may be changed. The recognition unit 130 may output a signal corresponding to the electrical state. Referring to FIG. 2B, in order to output the signal corresponding to the change in the electrical state, parallel electrodes may be installed on two ends of a uniform electric resistance film of the upper panel 131 and the lower panel 132 such that an equipotential distribution may be generated between the electrodes with the application of voltage. Referring to FIG. 2C, if the upper panel 131 makes contact with the lower panel by a physical force, an electric potential value may be outputted as the signal corresponding to the change in the electric state. Impedance according to the change in the electric potential may be obtained to recognize a point where strain may occur. Throughout this application, a force applied to a flexible display may cause an external pressure applied to the flexible display, or may cause an internal stress in the elements of the flexible display. Pressures and stresses may be calculated using engineering formulas, and may cause strains in the flexible display and/or its components.

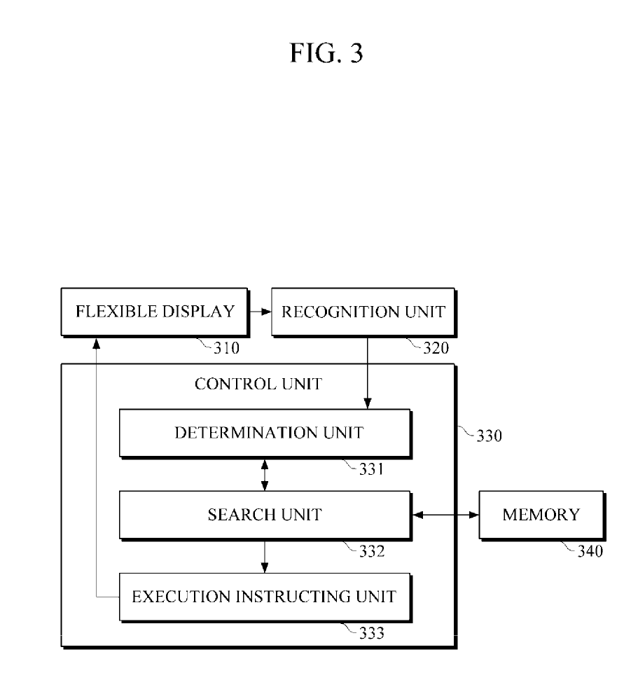

FIG. 3 is a block diagram illustrating an apparatus to recognize a strain in a flexible display according to an exemplary embodiment of the present invention.

Referring to FIG. 3, an apparatus to recognize a strain in a flexible display includes a flexible display 310, a recognition unit 320, a control unit 330 and a memory 340. Although not shown, the flexible display 310 may be provided with a touch input unit to receive an input from a user. The touch input unit may be provided in a form of a layer that may be disposed on the flexible display 310.

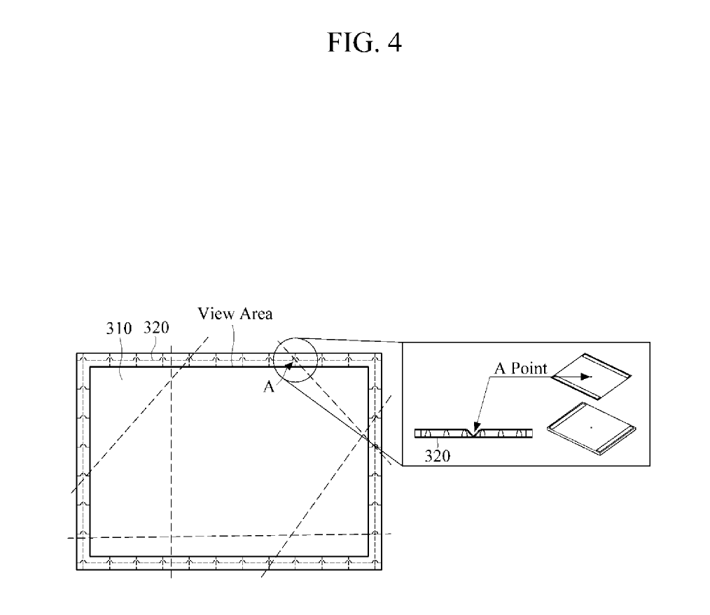

The recognition unit 320 may be configured to recognize a strain in the flexible display 310. As described above, the recognition unit 320 may be formed using an ITO conductive film. The change in an electric potential according to a pressure applied to the ITO conductive film may occur in the recognition unit 310. Details of the recognition unit 310 are described later with reference to FIG. 4.

The control unit 330 may determine a state of a strain in the flexible display 310 based on the electric potential value that may be outputted from the recognition unit 320, and control the flexible display 310 so that an operation may be performed according to the determined state of strain. The control unit 330 includes a determination unit 331, a search unit 332 and an execution instructing unit 333.

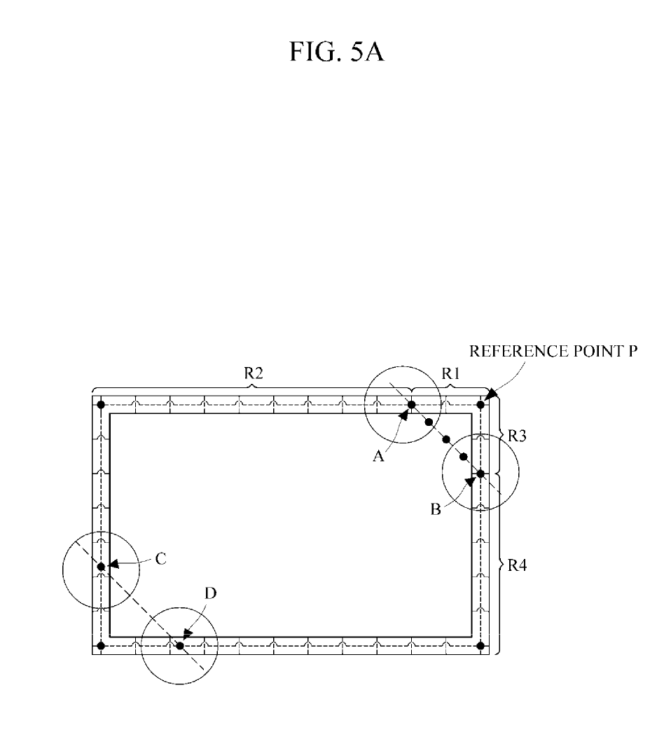

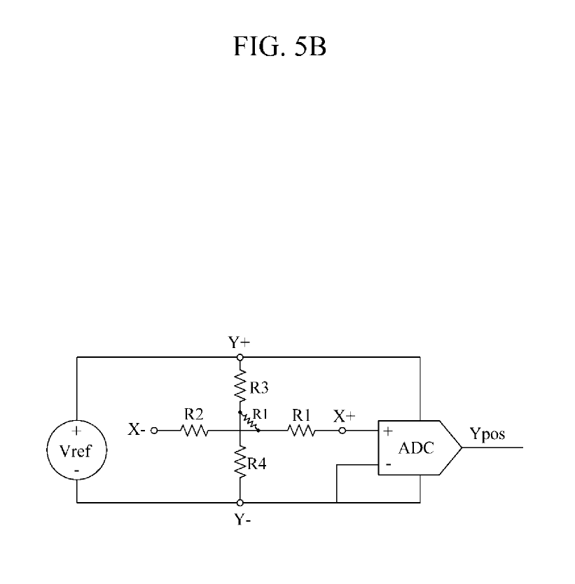

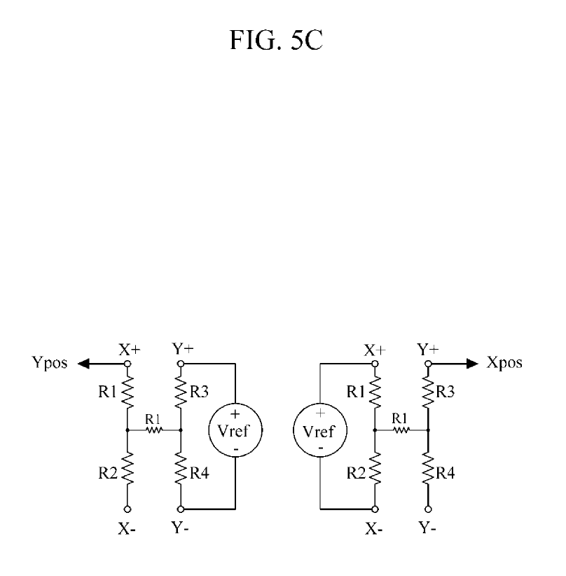

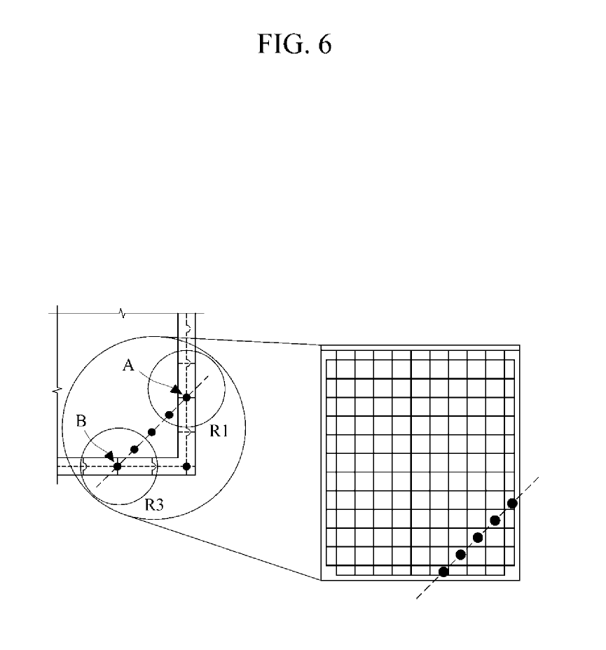

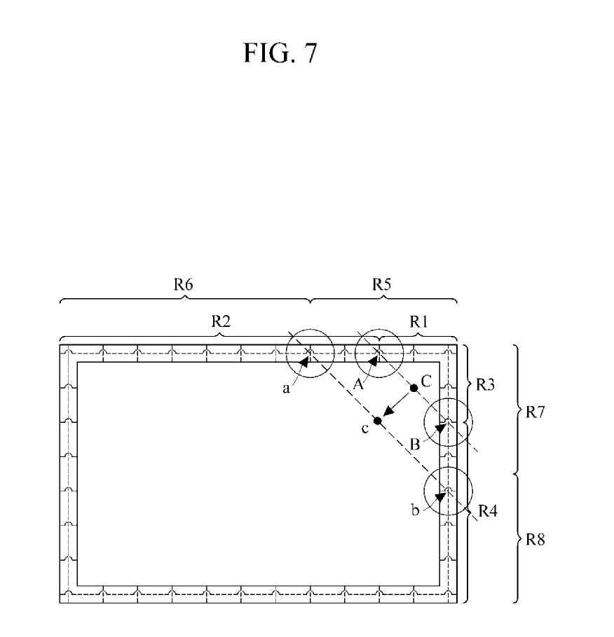

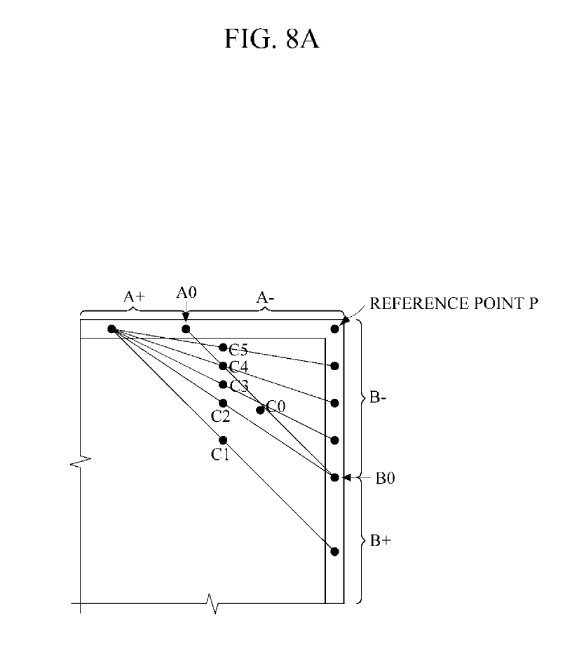

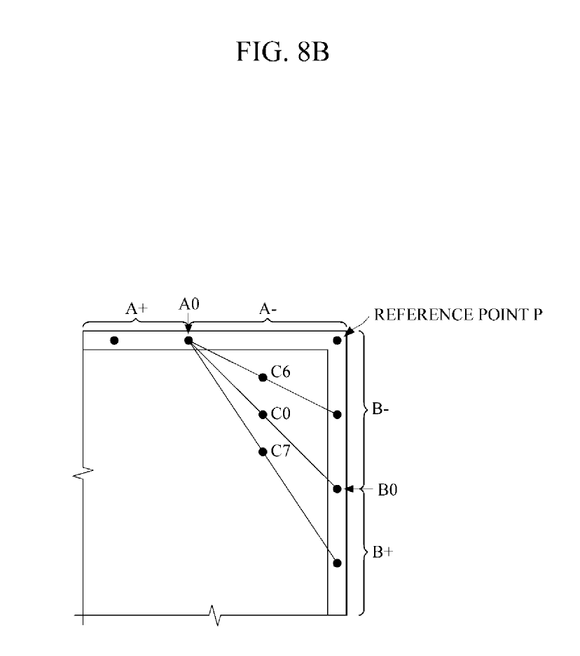

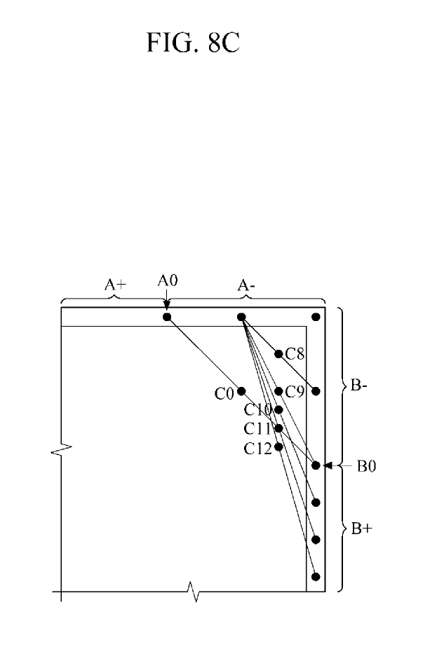

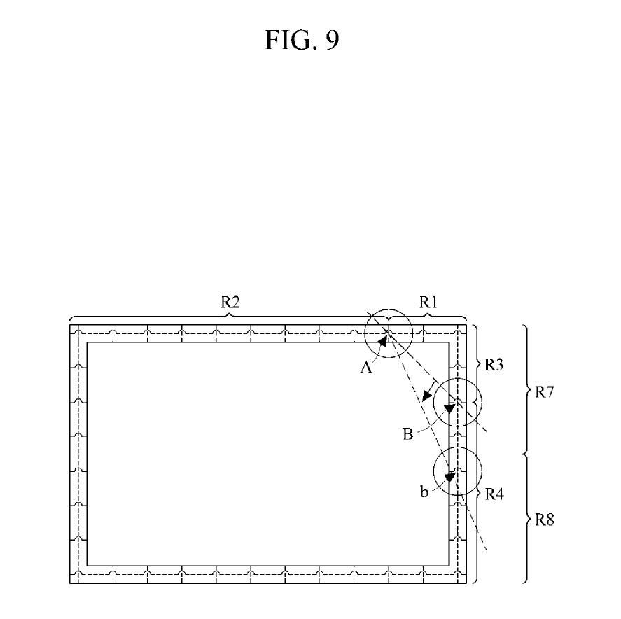

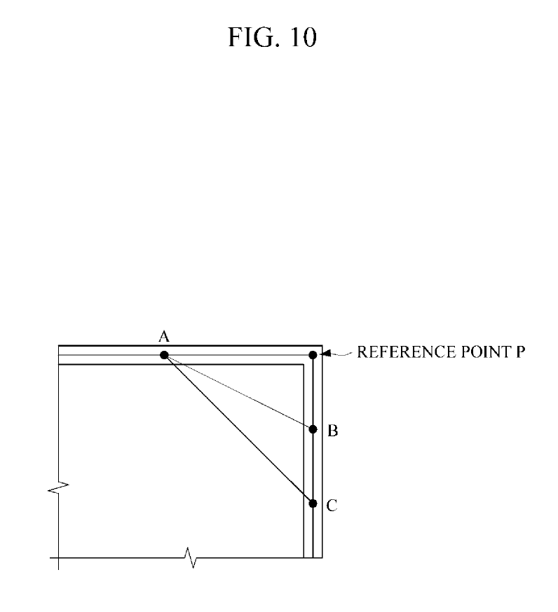

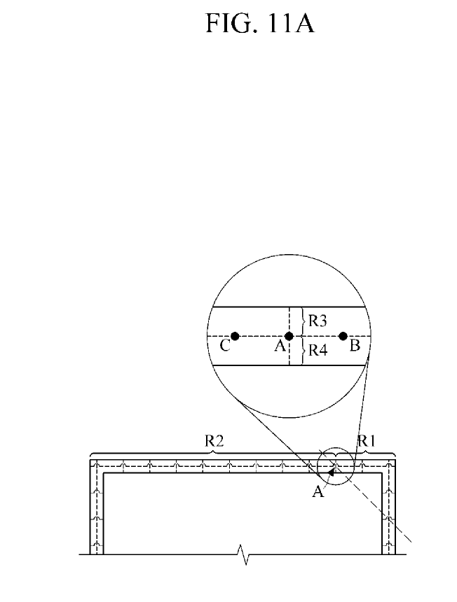

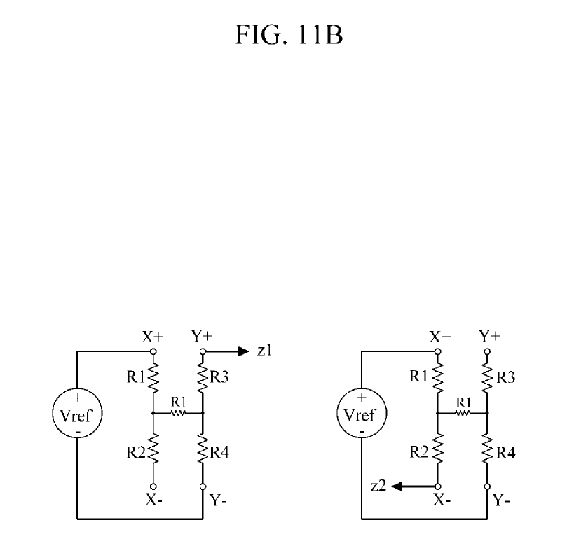

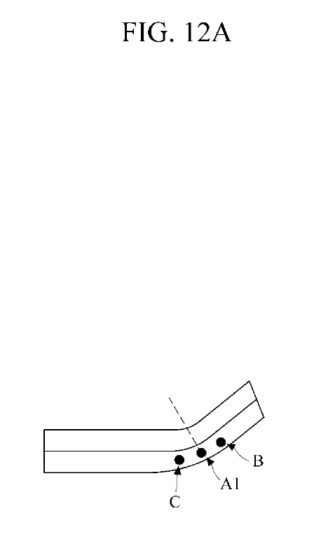

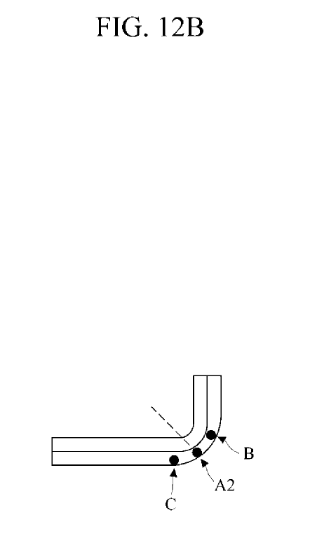

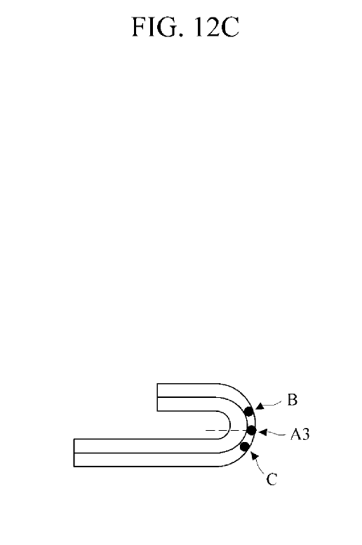

The determination unit 331 may determine the state of a strain in the flexible display 310 based on the electric potential value that may be outputted from the recognition unit 320. Information used to determine the state of a strain may include at least one of a position of a strain, a direction of a strain and a bending strength. A method for determining the state of a strain with the determination unit 331 will be described in detail with reference to FIG. 5, FIG. 6, FIG. 7, FIG. 8, FIG. 9, FIG. 10, FIG. 11, and FIG. 12.

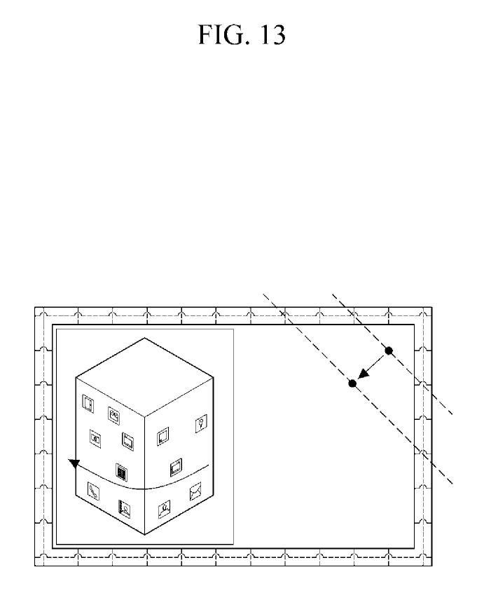

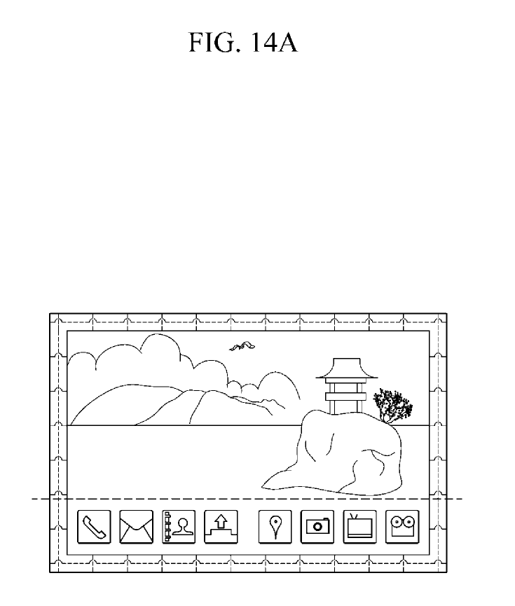

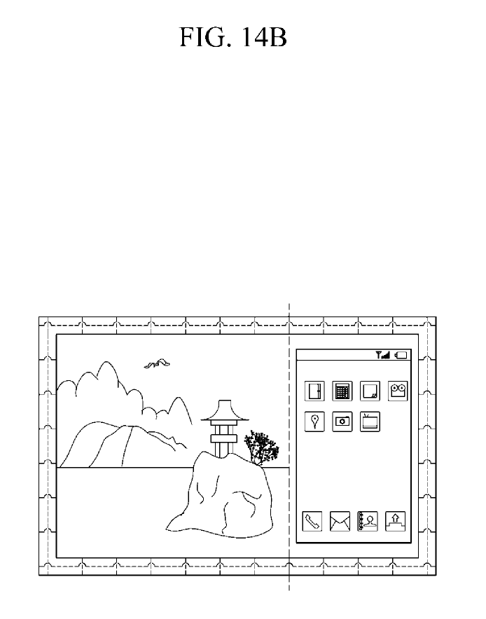

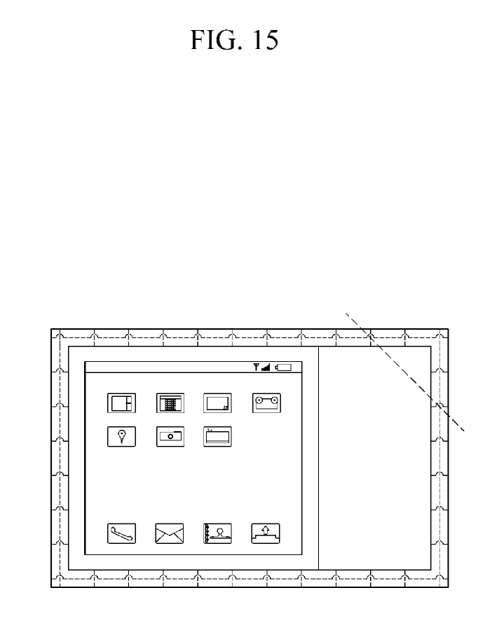

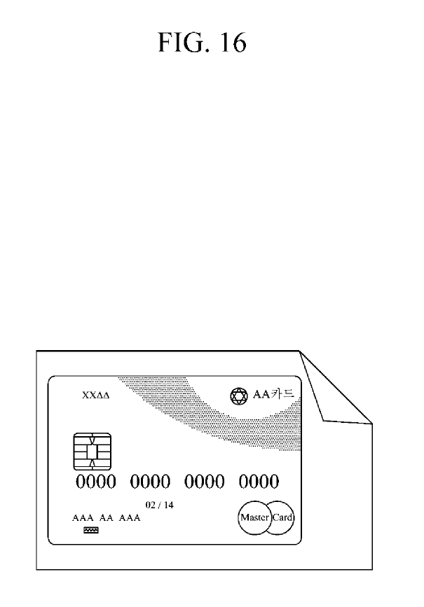

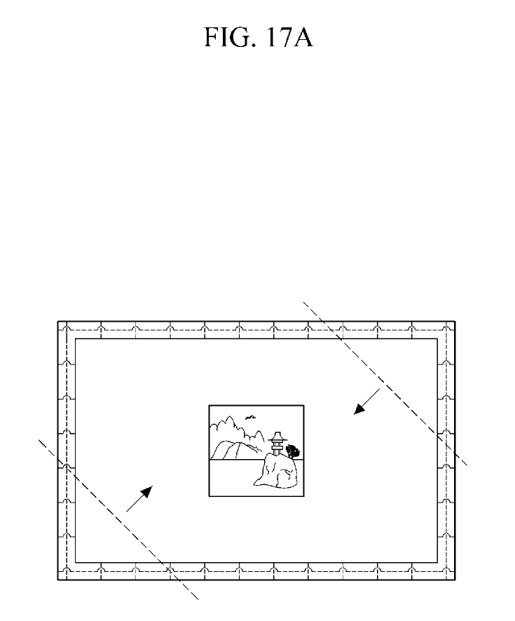

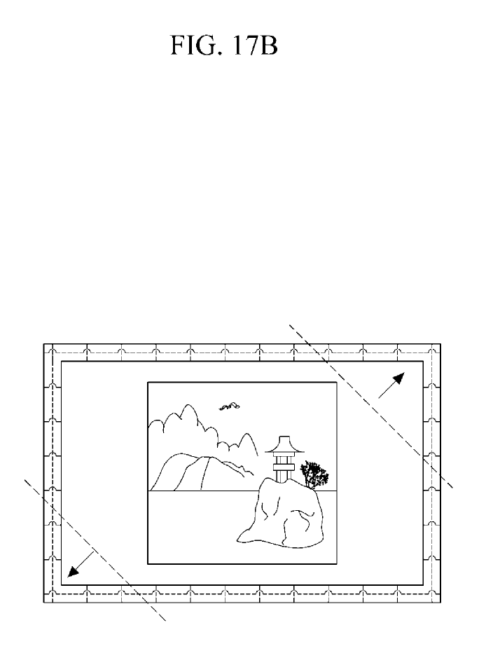

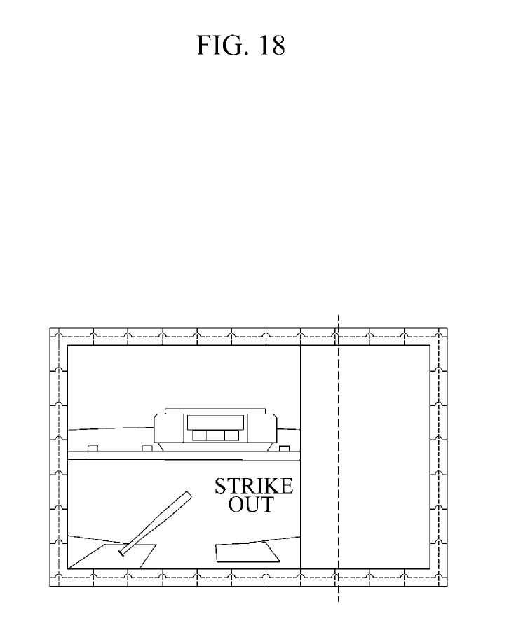

The search unit 332 may search for operation pattern information corresponding to the state of a strain in the flexible display 310, which may be determined by the determination unit 331. The operation pattern information may refer to information indicating how an electronic device having the flexible display 310 operates. For example, the operation pattern information may refer to information that indicates a partition area of a screen, which may be divided according to coordinates of a strain position, and an execution program that may be executed according to the strain position. Such operation pattern information may be stored in the memory 340. Various examples about the operation pattern information will be described later with reference to FIG. 13, FIG. 14, FIG. 15, FIG. 16, FIG. 17, and FIG. 18.

The execution instructing unit 333 may output an execution controlling signal to each component of an electronic device such that the electric device operates according to the operation pattern information. In FIG. 3, the execution controlling signal may output to the flexible display 310, but is not limited thereto. That is, the execution controlling signal may be outputted to other components of the electronic device based on the operation pattern information.

The memory 430 may store operation pattern information corresponding to the state of strain of the flexible display 310. The operation pattern information may be automatically stored if a reference menu or a reference application is generated. Further, the operation pattern information may be inputted by a user. The memory 340 may be implemented using a non-volatilized memory, such as an external storage device or ROM (read only memory)/NAND (Not AND) Flash.

FIG. 4 is a plan view illustrating a flexible display equipped with a recognition unit according to an exemplary embodiment of the present invention.

Referring to FIG. 4, the recognition unit 320 may be connected to the flexible display 310, such that the recognition unit 320 may partially surround the outer side of a view area of the flexible display 310, but is not limited thereto. That is, the recognition unit 320 may be connected onto an entire area of the view of the flexible display 310 or connected to a part of an inner side of the view area of the flexible display 310.

As the flexible display 310 detects at least one of a strain and a pressure (or stress) applied to a reference point of the recognition unit 320, for example, a point ‘A’, the upper panel may make contact with the lower panel at the point ‘A’. The recognition unit 320 may output an electric potential value according to the contact.

The determination unit 331 may calculate the position of the strain, the direction of the strain, and the bending strength that may indicate information used to determine the state of the strain.

If calculating the position of the strain, the determination unit 331 may determine coordinates of two or more points that may be positioned on a central segment. Referring to FIG. 4, in a structure having the recognition unit 320 connected to the flexible display 310, which may be bent or rolled, the flexible display 310 may be bent or rolled at a dotted line. In this regard, the central segment serving as a central region of the strain in the flexible display 310 may be determined. In general, a line is defined by two points. Accordingly, the position of the strain in the flexible display 310 may be determined or recognized by determining coordinates of at least two points positioned on the central region of the strain.

FIG. 5A, FIG. 5B, and FIG. 5C are views used to explain a position of a strain in a flexible display according to an exemplary embodiment of the present invention.

Referring to FIG. 5A, the recognition unit 320 is formed around the outer side of the flexible display 310. In this case, if the flexible display 310 is bent by a physical force or by other influence at a segment ‘AB’ consisting of a point A and a point B, the determination unit 331 may detect coordinates of the point A and point B where pressure is applied. That is, the determination unit 331 may detect a change of electric potential that is outputted from the recognition unit 320.

FIG. 5B and FIG. 5C may illustrate similar circuits according to the change of electric potential value. The change of electric potential value output from the recognition unit 320 may be obtained as the change of electric potential X+, X−, Y+ and Y− through the change of impedance based on the similar circuits, so that coordinates of a position Xpos and a position Ypos may be determined. The method for calculating the coordinates through the circuits of FIG. 5 is generally known in the art, and the detailed description will be omitted.

In this example, two points, such as points A and B, or points C and D may be obtained to define a segment. However, the exemplary embodiments of the present invention are not limited thereto. Further, coordinates of some or all point positioned on the segment may be obtained through the above described manner, and used. That is, according to how the recognition unit 320 may be connected to the flexible display 310, the determination unit 330 may be configured to detect coordinates of two or more points, and the number of points used as reference points among the detected points may be adjusted by a user or the determination unit 330.

The following description will be made with an understanding that at least three points are detected, but are not limited thereto.

FIG. 6 is a view illustrating detecting coordinates of three or more points associated with a strain in a flexible display according to an exemplary embodiment of the present invention.

Referring to FIG. 6, the ITO conductive film of each of the upper panel and the lower panel of the recognition unit 320 may include a plurality of ITO cells, for example, N number of ITO cells. The ITO cells of each of the upper panel and the lower panel may be provided in a lattice pattern. Each ITO cell may have electrodes at both ends. If the electric power is applied to some or all of the electrodes of the lower plate, a value of a point corresponding to a physical pressure applied may be obtained as an X-coordinate by reading out digital on/off signals through the pattern of the upper panel. If the electric power is applied to some or all of the electrodes of the upper plate, a value of the point corresponding to a physical pressure applied may be obtained as a Y-coordinate by reading out digital on/off signals through the pattern of the lower panel. At this time, if two or more points have physical pressure applied thereto, the coordinates of the points may be determined through the scheme described with reference to FIG. 5. In this manner, coordinates of multi-points may be determined. Since the precision of the coordinates may be in proportion to the precision of the pattern, the determination of the coordinates may not affected by analog environment.

If detecting the direction of a strain in the flexible display 310 of the determination unit 331, a partition point of a central segment, a slope of the central segment and the area of a folded portion defined by the central segment may be used.

Hereafter, exemplary embodiments of methods for detecting a direction of a strain in the flexible display using the partition point of a central segment or region may be described with reference to FIG. 7, FIG. 8A, FIG. 8B, and FIG. 8C.

FIG. 7 is a view illustrating detecting a direction of a strain in a flexible display according to an exemplary embodiment of the present invention.

Referring to FIG. 7, as the flexible display 310 is rolled toward the central region of the flexible display 310, the central segment or region may move from ‘AB’ to ‘ab’. As the point having a pressure applied is changed according to the movement of the central segment, the recognition unit 320 may output different electrical potential values. The determination unit 331 may determine the direction of a strain in the flexible display 310 based on the electric voltage value that is outputted from the recognition unit 320. As an example, the direction of the strain in the flexible display 310 may be determined based on the direction of movement of a central point of the central segment.

The determination unit 330 may calculate coordinates of the point A, the point B, the point a and the point b through the above described scheme, and coordinates of a central point or region ‘C’ of the segment ‘AB’ and a middle point or region ‘c’ of the segment ‘ab’ may be calculated. Through the change in the coordinates of the central points C and c, the direction of a strain in the flexible display 310 may be determined. Details thereof will be described with reference to FIG. 8A, FIG. 8B, and FIG. 8C.

FIG. 8A, FIG. 8B, and FIG. 8C are views illustrating recognizing a direction of a strain in a flexible display by use of a central point according to an exemplary embodiment of the present invention.

Referring to FIG. 8A, two points A0 and B0 form central segments defined by an initial strain and a central point or region C0, which may be positioned between the two points A0 and B0. If the point A0 moves to a direction of A+, the point B0 may have one of three cases among (a) moving to the direction of B+, (b) staying on the original position B0, and (c) moving to the direction of point B−. In table 1, five different results of movement of the central point C0 are shown according to each case of the movement of the point B0.

TABLE 1

| A | B | Central Point | Change in State |
|---|---|---|---|
| A0 | B0 | C0 | positioned on reference line |
| A+ | B+ | C1 | movement to positive (+) direction |
| | B0 | C2 | movement to positive (+) direction |
| | B− | C3 | movement to positive (+) direction |
| | | C4 | positioned on the reference line: no change |
| | | C5 | movement to negative (−) direction |

Referring to table 1, if the point B0 moves to the direction of B+ or stays on the original position, the central point C0 moves to a direction ‘+’. If the point B0 moves to the direction of B−, the central point C0 moves to either a ‘+’ direction or a ‘−’ direction based on a magnitude of the movement. More specifically, if the amount of movement of the point B0, in the direction of B−, is smaller than that of the movement of the point A0, the central point C0 moves to the direction ‘+’. If the amount of movement of the point B0, in the direction of B−, is equal to that of the movement of the point A0, the central point C0 is positioned on a reference line that may be positioned on the original point A0 and B0. If the amount of movement of the point B0, in the direction of B−, is larger than that of the movement of the point A0, the central point C0 moves a direction ‘−’.

In FIG. 8B, the description is made with an understanding that the point A0 is fixed and the point B0 is movable. The central point C0 moves according to the direction of movement of the point B0. In table 2, three different results of the movement of the central point C0 are shown according to each case of the movement of the point B0.

TABLE 2

| A | B | Central Point | Change in State |
|---|---|---|---|
| A0 | B− | C6 | movement to positive (+) direction |
| | B0 | C7 | positioned on reference line |
| | B+ | C8 | movement to positive (+) direction |

Referring to FIG. 8C, if the point B0 moves to a direction of B+, different results of movement of the central point C0 are shown according to each case of the movement of the point A0. In table 3, five different results of movement of the central point C0 are shown according to each case of the movement of the point A0.

TABLE 3

| A | B | Central Point | Change in State |
|---|---|---|---|
| A0 | B0 | C0 | positioned on a reference line |
| A− | B+ | C12 | movement to positive (+) direction |
| | | C11 | positioned on the reference line: no change |
| | | C10 | movement to negative (−) direction |
| | B0 | C9 | movement to negative (−) direction |
| | B− | C8 | movement to negative (−) direction |

FIG. 9 is a view illustrating detecting a direction of a strain in a flexible display by use of a change of a slope according to an exemplary embodiment of the present invention.

Referring to FIG. 9, the central segment has a slope. As the central segment moves, the slope of the central segment may change. In FIG. 9, the initial central segment may be a line connecting the point ‘A’ to the point ‘B’. As the point ‘B’ moves to the point ‘b’, the determination unit 331 may calculate the coordinates of the point ‘A’, the point ‘B’ and point ‘b’. The slope of a segment ‘AB’ may be obtained by use of the coordinates of the point ‘A’ and the point ‘B’. The slope of a segment ‘Ab’ may be obtained by use of the coordinates of the point ‘A’ and the point ‘b’. In this case, a determination may be made of whether the flexible display 310 has moved to a left, right, upward and downward direction through an amount of change in the slope of the central segment. In this example, the slope of the central segment may be obtained by using coordinates of two points. However, exemplary embodiments of the present invention are not limited thereto. According to another exemplary embodiment, the slope of the central segment may be obtained by use of coordinates of three or more points.

FIG. 10 is a view illustrating detecting a direction of the strain in a flexible display by use of a change of area according to an exemplary embodiment of the present invention.

As shown in FIG. 10, an initial central segment may refer to a line connecting a point ‘A’ to a point ‘B’. As the point ‘B’ moves to a point ‘C’, area of a triangle formed by a reference point ‘P’ and the points A and B of the initial central segment may be increased. The determination unit 331 may calculate the area of the triangle and determine the direction of a strain based on the amount of change in the area. In this example, the central segment may be obtained by use of coordinates of two points. However, the exemplary embodiments of the present invention are not limited thereto. According to another exemplary embodiment, the central segment may be obtained by use of coordinates of three or more points.

Hereinafter, bending strength according to the strain in the flexible display 310 will be described.

FIG. 11A and FIG. 11B are views illustrating detecting a bending strength according to a strain in a flexible display according to an exemplary embodiment of the present invention. FIG. 12A, FIG. 12B and FIG. 12C are views illustrating detecting a bending strength according to a strain in a flexible display according to an exemplary embodiment of the present invention.

An extent to which the flexible display is bent may be quantified. To this end, Z-axis may be considered in addition to X-axis Y-axis. The Z-axis may be used to refer to an intensity of pressure. The value of the Z-axis may be obtained through a change of impedance according to the pressure that may be applied if the flexible display is bent.

Referring to FIG. 11A, in a state that the flexible display is bent at point A, pressure applied to the point B and point C, which may be positioned around the point A, may be obtained through equivalent circuits shown in FIG. 11B. In detail, if the pressure applied to the conductive layer of the upper panel of the recognition unit 130 is Z1 and the pressure applied to the conductive layer of the lower panel of the recognition unit 130 is Z2, the pressure (R_{T}) applied to the entire area of the upper panel and the lower panel may be obtained through the values of Z1 and Z2.

A method for obtaining pressure applied to the entire area through the equivalent circuit of FIG. 11B is generally known in the art, and the detailed description will be omitted.

In this manner, pressure applied to each of the point A, the point B and the point C are obtained. The intensity of each pressure may be defined as A(R_{T}), B(R_{T}) and C(R_{T}). Since the point A positioned on the central segment receives a pressure greater than that applied to each of the point A and point B, A(R_{T}) may be greater than that of each of B(R_{T}) and C(R_{T}).

FIG. 12A, FIG. 12B and FIG. 12C illustrate bending strength according to the intensity of pressure. The bending strength may become greater in the order of the flexible display of FIG. 12A, the flexible display of FIG. 12B and the flexible display of FIG. 12C.

Accordingly, the determination unit 331 may determine whether flexible display 310 is bent or rolled based on the intensity of pressure.

Hereinafter, various examples of operation pattern information stored in the memory 340 are described with reference to FIG. 13, FIG. 14A, FIG. 14B, FIG. 15, FIG. 16, FIG. 17A, FIG. 17B and FIG. 18.

As shown in FIG. 13, an exemplary operation pattern may illustrate a cubical screen rotating on a flexible display in a direction of a strain, if a central point of a central segment moves according to a strain in the flexible display.

As shown in FIG. 14A or FIG. 14B, another exemplary operation pattern may illustrate a screen divided by a dotted line to display multiple application icon below the dotted line and an image above the dotted line, which may be shown if a flexible display is bent along the dotted line.

As shown in FIG. 15, another exemplary operation pattern may delete a file if the flexible display is bent along a dotted line.

As shown in FIG. 16, another exemplary operation pattern may request payment by a credit card, if the flexible display is bent along a dotted line.

As shown in FIG. 17A, another exemplary operation pattern may perform a zoom-out operation when taking a picture, if a flexible display is rolled upward in a direction of the arrow shown in FIG. 17A. As shown in FIG. 17B, another exemplary operation pattern may perform a zoom-in operation when taking a picture, if the flexible display is unrolled in the direction of the arrow shown in FIG. 17B.

As shown in FIG. 18, another exemplary operation pattern illustrates a bat being swung in a baseball game if a flexible display is bent at a dotted line. Strength of the swing may be adjusted according to the extent to which the flexible display is bent.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A terminal, comprising:
a flexible display to display an image;
a recognition unit to receive a physical input, and to detect a strain in the flexible display associated with the physical input; and
a control unit to determine a state of the strain, and to execute an operation according to the determined state of the strain.

2. The terminal of claim 1, wherein the recognition unit is connected to a portion of the flexible display.

3. The terminal of claim 1, wherein the control unit determines the state of strain based on an electric potential value outputted by the recognition unit.

4. The terminal of claim 1, wherein the recognition unit comprises:
a first panel comprising a first Indium Tin Oxide (ITO) film;
a second panel comprising a second ITO film; and
an adhesion layer with a space, disposed between the first panel and the second panel,
wherein at least one of the first ITO film and the second ITO film is coated with a uniform electric constant.

5. The terminal of claim 4, wherein if a pressure is applied to the flexible display detected by the recognition unit, an electrical state of a contact point between the first panel and the second panel is changed and the recognition outputs a signal corresponding to the changed electrical state.

6. The terminal of claim 4, wherein ends of the first ITO film and ends of the second ITO film comprise electrodes to output a control signal corresponding to a change in an electrical state of a contact point between the first panel and the second panel.

7. The terminal of claim 4, wherein the ITO conductive film comprises a plurality of ITO cells provided in a lattice pattern.

8. The terminal of claim 5, wherein the control unit determines a position of the strain based on the change in the electrical state.

9. The terminal of claim 7, wherein a position of the strain comprises an X-coordinate and a Y-coordinate, and if electric power is applied to the electrodes:
the X-coordinate is determined based on a reading of power signals through the pattern of the first panel, and
the Y-coordinate is determined based on a reading of power signals through the pattern of the second panel.

10. The terminal of claim 1, wherein information used to determine the state of strain comprises at least one of a position of the strain, a direction of the strain, and a bending strength of the flexible display.

11. The terminal of claim 10, wherein the control unit determines the direction of the strain based on a movement of a central point with respect to a first point and a second point corresponding to unstrained positions of the flexible display, and the central point is disposed between the first point and the second point.

12. The terminal of claim 10, wherein the control unit determines the direction of the strain based on a slope formed by a first point and a second point corresponding to unstrained positions of the flexible display, and a slope formed by the first point and a third point corresponding to a strained position of the flexible display.

13. The terminal of claim 10, wherein the control unit determines the direction of the strain based on a first area formed by a reference point with a first point and a second point corresponding to unstrained positions of the flexible display, and a second area formed by the reference point with the first point and a third point corresponding to a strained position of the flexible display.

14. The terminal of claim 10, wherein the control unit determines the bending strength by determining a position of a first point where the flexible display is bent and pressure applied to a second point and a third point surrounding the first point.

15. The terminal of claim 1, wherein the control unit determines whether the flexible display is folded or rolled based on a stress resulting from the physical input.

16. The terminal of claim 1, further comprising a memory unit to store operation pattern information.

17. The terminal of claim 1, wherein the control unit searches for operation pattern information corresponding to the state of strain of the flexible display, and executes the operation based on the operation pattern information.

18. The terminal of claim 16, wherein the operation pattern information comprises at least one of a controlling signal to operate the mobile terminal, information that indicates a partition area of the flexible screen that is divided according to a position of the strain, and an execution program to be executed according to the position of the strain.

19. An apparatus to recognize a strain in a flexible display, comprising:
a recognition unit to detect the strain in the flexible display, and to output an electric potential value;
a memory to store an operation pattern information that corresponds to a state of the strain in the flexible display; and
a control unit to determine the state of the strain based on the electric potential value, and to execute an operation corresponding to the operation pattern information,
wherein the recognition unit comprises a first panel, a second panel formed of an Indium Tin Oxide (ITO) film coated with a uniform electric constant, and an adhesion layer disposed between the first panel and the second panel, and
the recognition unit is connected to the flexible display.

20. An apparatus to detect a strain in a flexible display, comprising:
a recognition unit to receive a physical input, to detect the strain in the flexible display associated with the physical input, and to output an electric potential value based on the strain; and
a control unit to determine a state of the strain based on the electric potential value, and to execute an operation corresponding to the state of the strain,
wherein the state of the strain is associated with at least one of a position of the strain, a direction of the strain, and a bending strength of the flexible display.
